(19) United States
(12) Patent Application Publication
(10) Pub. No.: US 2025/0008303 A1
(43) Pub. Date: Jan. 2, 2025

(54) METHOD AND APPARATUS FOR OBTAINING MAC ADDRESSES OF DEVICES

(71) Applicant: SAMSUNG ELECTRONICS CO., LTD., Suwon-si (KR)

(72) Inventors: Suqin Xu, Jiangsu (CN); Jie Fan, Jiangsu (CN); Ruichao Liu, Jiangsu (CN); Suohua Li, Jiangsu (CN)

(73) Assignee: SAMSUNG ELECTRONICS CO., LTD., Suwon-si (KR)

(21) Appl. No.: 18/828,744

(22) Filed: Sep. 9, 2024

Related U.S. Application Data
(63) Continuation of application No. PCT/KR2023/007629, filed on Jun. 2, 2023.

(30) Foreign Application Priority Data
Jun. 7, 2022 (CN) 202210638771.8

(51) Int. Cl. H04W 4/029; H04W 4/02

(52) U.S. Cl. CPC H04W 4/029; H04W 4/023

(57) ABSTRACT

A method for obtaining a Media Access Control (MAC) address of a connectable ultra wide band (UWB) device includes obtaining, by a first device, device information of the connectable UWB device using a UWB signal; obtaining, by the first device synchronously with the obtaining the device information, first three-dimensional position set data of a target object, the device information comprising the MAC address and first position information of the connectable UWB device; and determining, by the first device, the MAC address of the connectable UWB device belonging to the target object based on the device information and the first three-dimensional position set data.

### CROSS-REFERENCE TO RELATED APPLICATION(S)

This application is a continuation of PCT International Application No. PCT/KR2023/007629, which was filed on Jun. 2, 2023, and claims priority to Chinese Patent Application No. CN202210638771.8, filed on Jun. 7, 2022, the disclosures of each of which are incorporated by reference herein their entirety.

### BACKGROUND

### 1. Field

The present disclosure relates to a wireless communication technology, and more particularly, to a method and apparatus for obtaining media access control (MAC) addresses of devices.

### 2. Description of Related Art

Currently, in many scenarios, it is necessary to obtain MAC addresses of terminal devices of users within a region in order to provide smart services to the users based on the MAC addresses of the terminal devices.

Existing methods for obtaining MAC addresses of terminal devices are difficult to implement. The specific reasons are as follows.

In the existing methods for the terminal to obtain MAC addresses of devices, before obtaining MAC addresses of devices, it is often necessary to establish a connection with a target terminal device by means of Bluetooth matching (e.g., pairing), etc. Thus, the existing methods rely on the manual operation of users, thereby causing application inconvenience. In particular, in many practical application scenarios (e.g. shopping malls), users often do not have the patience to operate mobile phones to establish a connection with smart devices in the scenarios, thereby making the existing methods for obtaining MAC addresses of devices unfavorable for application in these scenarios.

### SUMMARY

In view of this, a main purpose of the present disclosure is to provide a method and apparatus for obtaining MAC addresses of devices, which can effectively improve the convenience of obtaining MAC addresses.

In order to achieve the aforementioned purpose, embodiments of the present disclosure propose the following technical solutions.

According to an aspect of the disclosure, a method for obtaining a Media Access Control (MAC) address of a connectable ultra wide band (UWB) device, the method comprising: obtaining, by a first device, device information of the connectable UWB device using a UWB signal; obtaining, by the first device synchronously with the obtaining the device information, first three-dimensional position set data of a target object, the device information comprising the MAC address and first position information of the connectable UWB device; and determining, by the first device, the MAC address of the connectable UWB device belonging to the target object based on the device information and the first three-dimensional position set data.

According to an aspect of the disclosure, the obtaining the device information comprising the first position information of the connectable UWB device further comprises: positioning, by the first device, the connectable UWB device using the UWB signal to obtain a position coordinate of the UWB device; and mapping, by the first device, the position coordinate obtained by the positioning into a coordinate system corresponding to the first three-dimensional position set data to obtain the first position information of the connectable UWB device

According to an aspect of the disclosure, the obtaining the first three-dimensional position set data of the target object further comprises: acquiring, by the first device while obtaining the device information, three-dimensional position set data of the target object using a depth camera; selecting, by the first device from the acquired three-dimensional position set data, three-dimensional position set data acquired at a time closest to a first time corresponding to a time when the device information is obtained; and obtaining, by the first device, the first three-dimensional position set data of the target object based on the selected three-dimensional position set data.

According to an aspect of the disclosure, the obtaining the first three-dimensional position set data of the target object based on the selected three-dimensional position set data further comprises: expanding, by the first device according to a preset expansion parameter, a space region corresponding to the selected three-dimensional position set data to obtain the first three-dimensional position set data of the target object.

According to an aspect of the disclosure, the determining the MAC address of the connectable UWB device belonging to the target object further comprises: searching, by the first device, for the connectable UWB device belonging to the target object by matching a device position of the UWB device with a target space region based on the first position information and the first three-dimensional position set data, wherein the target space region is a space region corresponding to the first three-dimensional position set data of the target object; and obtaining, by the first device, the MAC address of the searched connectable UWB device based on the device information.

According to an aspect of the disclosure, the method further comprises: obtaining, by the first device while obtaining the first three-dimensional position set data of the target object, first three-dimensional position set data of each second object, wherein each second object is an object other than the target object within a preset first expanded region where the target object is located, wherein the searching for the connectable UWB device belonging to the target object further comprises: searching, by the first device, for the connectable UWB device located in the target space region based on the first position information and the first three-dimensional position set data of the target object; based on determining that the searched connectable UWB device does not exist in other space regions, determining, by the first device, the searched connectable UWB as the UWB device belonging to the target object; and based on determining that the searched connectable UWB device exists in other space regions, determining, by the first device, that the search fails, wherein the other space regions are space regions corresponding to the first three-dimensional position set data of the second object.

According to an aspect of the disclosure, the obtaining the first three-dimensional position set data of each second object further comprises: acquiring, by the first device while obtaining the device information, three-dimensional position set data of each second object using a depth camera; selecting, by the first device from the acquired three-dimensional position set data of each second object, three-dimensional position set data acquired at a time closest to a first time corresponding to a time that the device information is obtained; and obtaining, by the first device, the first three-dimensional position set data of each second object based on the selected three-dimensional position set data.

According to an aspect of the disclosure, the obtaining the first three-dimensional position set data of each second object based on the selected three-dimensional position set data comprises: expanding, by the first device according to a preset expansion parameter, a space region corresponding to the selected three-dimensional position set data to obtain the first three-dimensional position set data of the second object.

According to an aspect of the disclosure, the method further comprises: after determining the MAC address of the connectable UWB device belonging to the target object, based on determining the target object is required to be repositioned, obtaining, by the first device, the MAC address and position information of the connectable UWB device using the UWB signal, and searching, by the first device, for position information that matches the determined MAC address from the obtained position information as current position information of the target object.

According to an aspect of the disclosure, the method further comprises: after determining the MAC address of the connectable UWB device belonging to the target object, sending, by the first device, information required for the target object to the connectable UWB device belonging to the target object using the determined MAC address.

According to an aspect of the disclosure, after determining the MAC address of the connectable UWB device belonging to the target object, obtaining, by the first device, user tag information corresponding to the determined MAC address from a preset database; generating, by the first device, first push information based on the user tag information, the first push information comprising generation of a MAC address of the first device or contact information of a user owning the first device; and sending, by the first device, the first push information to the UWB device belonging to the target object based on the determined MAC address to trigger the target object to send information to the user owning the first device based on the MAC address or contact information of the user indicated by the first push information based on determining that the target object needs to interact with the user owning the first device based on the first push information.

According to an aspect of the disclosure, determining the target object comprises: based on determining the first device receives a preset target object setting instruction, determining, by the first device, an object which issues the target object setting instruction as the target object; or, wherein determining the target object comprises: based on determining the first device detects that a duration for which a user owning the first device gazes at an object reaches a preset threshold, determining, by the first device, the gazed object as the target object; or, wherein determining the target object comprises: based on determining the first device detects that an object in a currently captured picture is known to a user owning the first device, determining, by the first device, the object as the target object; obtaining, by the first device, first three-dimensional position set data of each second object using a depth camera, the second object being an object other than the target object within a preset first expanded region where the target object is located; in a presence of the second object, searching for a second object having a distance, less than a preset threshold, to each of the determined target objects from the second object based on the first three-dimensional position set data of the second object and the first three-dimensional position set data of the target object, and based on determining the search is successful, determining, by the first device, the searched second object as the target object; or, wherein determining the target object comprises: based on determining the first device monitors an object having a preset abnormal behavior, determining, by the first device, the object as the target object.

According to an aspect of the disclosure, an apparatus for obtaining a Media Access Control (MAC) address of a connectable ultra wide band (UWB) device, the apparatus comprises: data obtaining circuitry, configured to: obtain device information of the connectable UWB device using a UWB signal, and obtain, synchronously with obtaining the device information, first three-dimensional position set data of a target object, the device information comprising the MAC address and first position information of the UWB device; and address matching circuitry configured to determine the MAC address of the connectable UWB device belonging to the target object based on the device information and the first three-dimensional position set data.

According to an aspect of the disclosure, a device for obtaining a Media Access Control (MAC) address of a connectable ultra wide band (UWB) device, the device comprising: a memory that stores one or more instructions; and a processor operatively coupled to the memory and configured to execute the one or more instructions stored in the memory, wherein the one or more instructions, when executed by the processor, cause the device to: obtain device information of the connectable UWB device using a UWB signal, obtain, synchronously with obtaining the device information, first three-dimensional position set data of a target object, the device information comprising the MAC address and first position information of the connectable UWB device, and determine the MAC address of the connectable UWB device belonging to the target object based on the device information and the first three-dimensional position set data.

According to an aspect of the disclosure, a non-transitory computer-readable storage medium having instructions stored therein, which when executed by a processor in a device cause the processor to execute a method for obtaining a Media Access Control (MAC) address of a connectable ultra wide band (UWB) device, the method comprising: obtaining device information of the connectable UWB device using a UWB signal; obtaining, synchronously with the obtaining the device information, first three-dimensional position set data of a target object, the device information comprising the MAC address and first position information of the connectable UWB device; and determining the MAC address of the connectable UWB device belonging to the target object based on the device information and the first three-dimensional position set data.

In summary, in the solutions for obtaining MAC addresses of devices proposed by the embodiments of the present disclosure, a MAC address and position information of each connectable UWB device near a device are first obtained using a UWB, and meanwhile, three-dimensional position set data of a target object is obtained. Then, a UWB device belonging to the target object is selected from all the currently connectable UWB devices based on the position information of all the currently connectable UWB devices and the three-dimensional position set data of the target object. And then, a MAC address corresponding to the UWB device may be determined. Thus, since a user is not required to operate a UWB device to be paired and connected with a first device, the convenience of obtaining MAC addresses can be effectively improved.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a flowchart of a method according to one or more embodiments of the present disclosure;

FIG. 2 is a schematic diagram of implementing operation b2 according to one or more embodiments of the present disclosure;

FIG. 3 is a schematic diagram of enlarging a space region of a target object according to one or more embodiments of the present disclosure;

FIG. 4 is a schematic diagram of intersecting space regions of two objects according to one or more embodiments of the present disclosure;

FIG. 5 is a flowchart of implementing a robot guiding a customer according to one or more embodiments of the present disclosure;

FIG. 6 is a schematic diagram of a first example of a robot searching for a nearby UWB device according to one or more embodiments of the present disclosure;

FIG. 7 is a schematic diagram of a second example of a robot searching for a nearby UWB device according to one or more embodiments of the present disclosure;

FIG. 8 is a schematic diagram of requesting to obtain target person tag data from a database server according to one or more embodiments of the present disclosure;

FIG. 9 is a schematic diagram of a scenario of a photograph sharing example 4.1 according to one or more embodiments of the present disclosure;

FIG. 10 is a schematic diagram of a scenario of a photograph sharing example 4.2 according to one or more embodiments of the present disclosure;

FIG. 11 is a schematic diagram of determining a person with an abnormal behavior as a target person in a monitoring scenario;

FIG. 12 is a schematic diagram of a target person walking out of a visual range of a monitoring device in a monitoring scenario; and

FIG. 13 is a schematic structure diagram of an apparatus according to one or more embodiments of the present disclosure.

### DETAILED DESCRIPTION

In order to more clarify the purposes, technical solutions and advantages of the present disclosure, the present disclosure may be further described in detail below with reference to the accompanying drawings and specific embodiments.

It should be understood at the outset that although illustrative implementations of the embodiments of the present disclosure are illustrated below, embodiments of the disclosure may be implemented using any number of techniques, whether currently known or in existence.

The present disclosure should in no way be limited to the illustrative implementations, drawings, and techniques illustrated below, including the exemplary design and implementation illustrated and described herein, but may be modified within the scope of the appended claims along with their full scope of equivalents.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present embodiments. Furthermore, in terms of the construction of the device, one or more components of the device may have been represented in the drawings by conventional symbols, and the drawings may show only those specific details that are pertinent to understanding the embodiments of the present embodiments so as not to obscure the drawings with details that may be readily apparent to those of ordinary skill in the art having the benefit of the description herein.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do NOT exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

Embodiments of the present disclosure may be described below in detail with reference to the accompanying drawings.

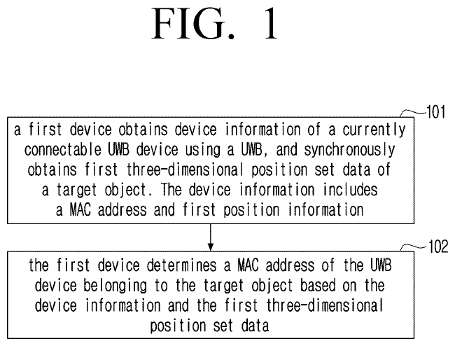

FIG. 1 is a flowchart of a method for obtaining MAC addresses of devices according to one or more embodiments of the present disclosure. As shown in FIG. 1, in one or more examples, the process includes the following operations.

In operation 101, a first device obtains device information of a currently connectable ultra wideband (UWB) device using a UWB signal, and synchronously obtains first three-dimensional position set data of a target object. The device information includes a MAC address and first position information. In one or more examples, a UWB device may be a device that utilizes a radio technology that can use a very low energy level for short-range, high-bandwidth communications over a large portion of the radio spectrum. For example, a UWB device may be device that uses a short-range RF technology for wireless communication that can be leveraged to detect the location of people, devices, and assets. In one or more examples, a UWB device may be any smartphone, tablet, PC, IoT device, etc. that utilizes the aforementioned radio technology.

In this operation, UWB devices near a first device may be searched using a UWB search method to obtain a MAC address of each UWB device currently connectable to the first device. In one or more examples, a UWB positioning method may be used to obtain position information of each of the searched UWB devices and synchronously obtain first three-dimensional position set data of a target object, whereby a UWB device belonging to a target device is found in subsequent operations based on the position information of the UWB devices and three-dimensional position set data of the target device. Subsequently, a MAC address corresponding to the UWB device may be determined. Thus, based on these embodiments, a user is not required to operate a UWB device to be paired and connected with a first device, and a MAC address corresponding to a target object may be more easily obtained, thereby resulting in obtaining MAC addresses with significantly improved convenience and efficiency.

In one or more examples, the first device may be, but is not limited to, a smart robot, a monitoring device, a mobile phone terminal, smart glasses, etc., which are configured with UWB chips.

The UWB device may be a device configured with a UWB chip, which may include, but not limited to, a mobile phone, an earphone, a smart watch, and other wearable smart devices.

In one or more examples, the object may be a person, or other specified things, and may be specifically set by those skilled in the art according to the requirements of one or more examples.

It should be noted here that after a UWB function of a UWB device is turned on, a MAC address of the device may be broadcast via a UWB module. In this way, a first device searches for UWB devices within a UWB signal coverage range thereof via a UWB, and a MAC address of each connectable UWB device nearby may be obtained. Any UWB search method known to one of ordinary skill in the art may be used to search for connectable UWB devices. The coordinate systems used by a camera of the device and a UWB positioning component may be different from each other

In one or more examples, in a case where coordinate systems adopted by a camera component and a UWB positioning component of a device are different from each other, in order to accurately find a UWB device belonging to a target device based on position information of the UWB device and three-dimensional position set data of the target device in subsequent operations, coordinate conversion may be performed on the position of the UWB device obtained by UWB positioning, where the position information of the UWB device and the three-dimensional position set data of the target device are in the same coordinate system. Based on these features, the first position information of the currently connectable UWB device may be obtained in operation 101 specifically using the following operations a1 and a2:

In operation a1, the UWB device is positioned using a UWB signal.

In this operation, the positioning may be specifically implemented using any UWB positioning method known to one of ordinary skill in the art. For example, UWB positioning may use radio signals to determine a distance between a reference point and a target, and may be used for localization. Example UWB positioning methods include transit time methodology, signal arrival time, and time different of arrival (TDOA). In the transmit time methodology, the time it takes for light to travel between an object and multiple receivers. The transmit time methodology may be referred to as time of flight (ToF). In the signal arrival time methodology, trilateral ranging may be used to estimate a location of a target point based on signal arrival time. In the TDOA methodology, RF signals may be used to determine a distance between the target and the reference point.

It should be noted here that after a UWB function of a UWB device is turned on, a MAC address of the device may be broadcast. In this way, a first device searches for UWB devices within a UWB signal coverage range thereof via a UWB, and MAC addresses of connectable UWB devices nearby may be obtained.

In operation a2, a position coordinate obtained by the positioning may be mapped into a coordinate system corresponding to the three-dimensional position set data to obtain the first position information of the UWB device.

In one or more examples, a coordinate (e.g., first position information) of a UWB positioning coordinate in the coordinate system corresponding to the three-dimensional position set data may be obtained through the mapping operation in this operation. In this way, the first position information and the three-dimensional position set data of the target object correspond to the same coordinate system, whereby it may be accurately determined whether the first position information is in a space region corresponding to the three-dimensional position set data. Subsequently, a UWB device belonging to a target object may be determined.

In one or more examples, three-dimensional position set data of the target object may be obtained using a depth camera. In one or more examples, a depth camera may be a device that determines a distance between the camera and a target or between two entities. Example depth cameras include, but are not limited to, stereo depth cameras, LiDAR sensors, ToF camera systems, and direct ToF (dToF) systems. Further, in order to determine the UWB device belonging to the target object more accurately, in one or more examples, first three-dimensional position set data of the target object may be obtained synchronously using the following operations b1-b3:

In operation b1, three-dimensional position set data of the target object may be acquired using a depth camera while the device information is obtained.

In this operation, three-dimensional position set data of the target object may be acquired while obtaining the device information so as to obtain three-dimensional position set data synchronized with the position information of the UWB device.

In one or more examples, the method for acquiring three-dimensional position set data of the target object may be based on any one of the aforementioned UWB positioning methods using a depth camera.

In operation b2, three-dimensional position set data acquired at a time nearest to a first time is selected from the acquired three-dimensional position set data. The first time may correspond to a time when the device information is obtained.

In one or more examples, to synchronize three-dimensional position set data subsequently used for determining a UWB device belonging to a target object and position information of the UWB device, three-dimensional position set data acquired at a time (e.g., a time when the depth camera captures a certain frame) nearest to the first time (e.g., time when device information of the UWB device is obtained) may be selected from multiple frames acquired by the depth camera.

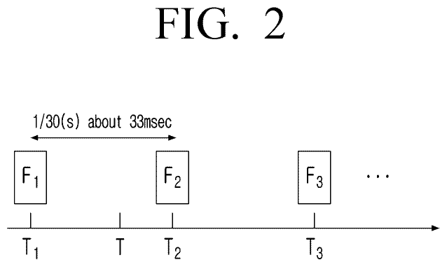

For example, as shown in FIG. 2, it is assumed that the frame rate of the depth camera is 30 frames per second. When the first device obtains device information (e.g., MAC address, position, etc.) of the UWB device at time T, a previous frame of time T is a time T1 obtaining frame F1, and a next frame of time T is a time T2 obtaining frame F2. If a duration from time T to T2 is shorter than a duration from time T to T1, frame F2 is selected as a three-dimensional position set of the target object.

In operation b3, the first three-dimensional position set data of the target object is obtained based on the selected three-dimensional position set data.

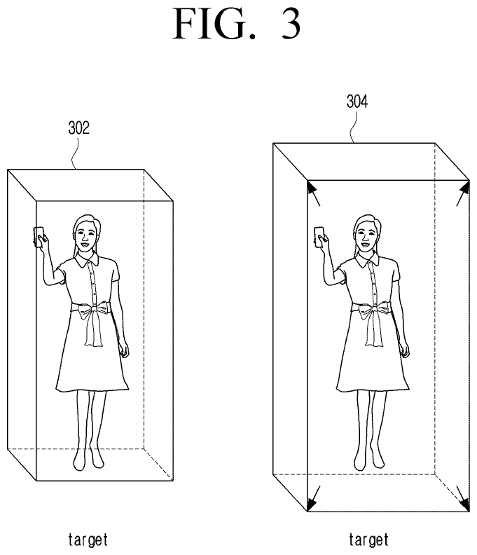

In one or more examples, considering that there may be some errors in UWB positioning in one or more examples, in order to determine the UWB device belonging to the target object more accurately, the space region corresponding to the three-dimensional position set data acquired by the depth camera may be expanded appropriately (as shown in FIG. 3). FIG. 3 illustrates an example space region 302, and an expanded spaced region 304. Specifically, the first three-dimensional position set data of the target object may be obtained in operation b3 using the following method:

A space region corresponding to the selected three-dimensional position set data is expanded according to a preset expansion parameter to obtain the first three-dimensional position set data of the target object.

In one or more examples, an expansion parameter is used for defining the expansion degree of the space region. Specifically, a suitable value may be set to, for example but not limited to, 5 cm according to an error size of UWB positioning in one or more examples. In one or more examples, the space region may be a rectangular box, where the expansion parameter may include (i) a first parameter that increases a length of the rectangular box by a first predetermined amount, and (ii) a second parameter that increases a width of the rectangular box by a predetermined amount. In one or more examples, the space region may be a 3D sphere, where the expansion parameter may be a parameter that increases a radius of the 3D sphere by a predetermined amount.

Further, considering that there may be other objects near the target object in one or more example scenarios, and UWB devices of these objects may be easily misidentified as the UWB devices of the target object, in order to avoid such misjudgment and further improve the identification accuracy of the UWB device of the target object, in one or more examples, first three-dimensional position set data of other objects near the target object may be obtained while first three-dimensional position set data of the target object is obtained to avoid the aforementioned misjudgment by combining the first three-dimensional position set data of the other objects in subsequent operations. This purpose may be achieved using the following methods:

In operation 1001, first three-dimensional position set data of each second object is obtained while first three-dimensional position set data of the target object is obtained. The second object is an object other than the target object within a preset first expanded region where the target object is located, that is, another object having a distance, less than a certain threshold, to the target object.

The first expanded region may be a vicinity region of the target object. In one or more examples, the expanded region may be region that encompasses the target object.

In one or more examples, first three-dimensional position set data of each second object may be obtained specifically using the following operations c1-c2:

In operation c1, three-dimensional position set data of the second object is acquired using a depth camera while the device information is obtained.

In operation c2, three-dimensional position set data acquired at a time nearest to a first time is selected from the acquired three-dimensional position set data of each second object, and the first three-dimensional position set data of the object may be obtained based on the selected three-dimensional position set data. The first time may be a time corresponding to when the device information is obtained.

In one or more examples, the first three-dimensional position set data of the object may be obtained in operation c2 based on the selected three-dimensional position set data in a space region expansion manner using the following method:

A space region corresponding to the selected three-dimensional position set data may be expanded according to a preset expansion parameter to obtain the first three-dimensional position set data of the second object.

In one or more examples, a strategy of determining a target object may be performed according to one or more example scenario settings. For example, a target object in an application scenario may be determined using the following several methods:

### Method 1:

When the first device receives a preset target object setting instruction, an object which issues the target object setting instruction is determined as the target object.

The target object setting instruction may be set by those skilled in the art according to environment specific application requirements. For example, in a shopping mall, when a first device serves as a smart robot, the target object setting instruction may be an instruction requesting to be guided.

In one or more examples, the target object setting instruction may be a voice instruction. At this moment, an object issuing the target object setting instruction may be identified using existing stereo detection methods.

### Method 2:

When the first device detects that a duration for which a user owning the first device gazes at an object reaches a preset threshold, the gazed object is determined as the target object.

By means of Method 2, a user may select a target object through smart glasses.

### Method 3:

In operation d1, when the first device detects that an object in a currently captured picture is known to a user owning the first device, the object is determined as the target object.

In one or more examples, the first device may use a face detection technology to identify an object in a currently captured picture based on an album or contact record information in the device, and determine that the object in the picture is known to the user if the object exists in the album or contact record information in the device.

In operation d2, the first device obtains first three-dimensional position set data of each second object using a depth camera. In one or more examples, the second object is an object other than the target object within a preset first expanded region where the target object is located.

In operation d3, in the presence of the second object, a second object having a distance, less than a preset threshold, to each of the determined target objects is searched from the second object based on the first three-dimensional position set data of the second object and the first three-dimensional position set data of the target object, and if the search is successful, the searched second object is determined as the target object.

By means of operations d2 and d3, other objects nearer to the target object determined in operation d1 may be determined as the target object.

### Method 4:

When the first device monitors an object having a preset abnormal behavior, the object is determined as the target object.

By means of Method 4, non-dead angle monitoring may be performed on a peripheral region of the first device.

The aforementioned four methods are merely exemplary illustrations of methods for determining a target object, and the methods in one or more examples are not limited to the aforementioned methods. Those skilled in the art are able to set a suitable target object determination strategy based on an environment in which the target object is located.

In operation 1002, the first device determines a MAC address of the UWB device belonging to the target object based on the device information and the first three-dimensional position set data.

In this operation, a MAC address of the UWB device belonging to the target object is determined based on the matching of the position information and the three-dimensional position set data of the target object.

In one or more examples, a MAC address of the UWB device belonging to the target object may be determined specifically using the following methods:

In operation e1, a UWB device belonging to the target object is searched in by matching a device position with a target space region based on the first position information and the first three-dimensional position set data.

In one or more examples, the target space region is a space region corresponding to the first three-dimensional position set data of the target object.

In one or more examples, it may be directly determined whether the UWB device is located in a target space region (e.g., a space region corresponding to the first three-dimensional position set data of the target object) and whether the UWB device belongs to the target object in operation e1.

In one or more examples, when first three-dimensional position set data of a second object near the target object is determined simultaneously in operation 1001, a UWB device belonging to the target object may be searched using the following methods:

In operation f1, a UWB device located in the target space region is searched from the UWB device based on the first position information and the first three-dimensional position set data of the target object.

In operation f2, it is determined whether the searched UWB device does not exist in other space regions. If it is determined that the searched UWB device does not belong in other space regions, the searched UWB is determined as a UWB device belonging to the target object. However, if it is determined that the UWB device exists in other space regions, it is determined that the search fails. The other space regions may be space regions corresponding to the first three-dimensional position set data of the second object.

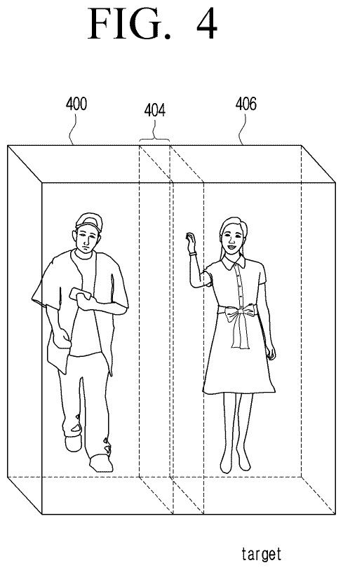

For example, when the UWB device found in operation f1 exists in space regions of other objects, for example, the UWB device exists in an intersection part of two space regions as shown in FIG. 4, it cannot be determined to which object the UWB device belongs. For example, FIG. 4 illustrates space regions 402 and 406 that include an intersecting portion 406, and therefore, the searched for UWB is included in other space regions. At this moment, it is determined that the search fails. When the space regions of two objects no longer intersect or are spaced apart by a certain distance (e.g., 10 cm), operation 1001 is re-executed to re-obtain a MAC address.

In operation e2, a MAC address of the searched UWB device is obtained based on the device information.

In this operation, device information matching the position information of the UWB device found in operation e1 is searched from the device information obtained in operation 101, and a MAC address of the UWB device belonging to the target object may be obtained from the device information.

By means of the aforementioned operations 101-102, the MAC address of the UWB device of the target object may be obtained without the first device establishing a connection with the UWB device of the target object, thereby enhancing the convenience of obtaining MAC addresses of devices.

After the first device determines the MAC address of the UWB device belonging to the target object in operation 102, a corresponding service processing flow may be performed on the target object based on the determined MAC address according to one or more examples.

For example, after determining a MAC address of the UWB device belonging to the target object in operation 1002, the first device obtains a MAC address and position information of a currently connectable UWB device using a UWB if the target object is required to be repositioned, and searches for position information matching the determined MAC address from the currently obtained position information as current position information of the target object.

In one or more examples, after determining a MAC address of the UWB device belonging to the target object in operation 102, the first device sends information required for the target object to the UWB device belonging to the target object using the determined MAC address.

In one or more examples, after determining a MAC address of the UWB device belonging to the target object in operation 1002, the first device obtains user tag information corresponding to the determined MAC address from a preset database, generates, based on the user tag information, first push information including generation of a MAC address of the first device and/or contact information of a user owning the first device, and sends the first push information to the UWB device belonging to the target object based on the determined MAC address, so as to trigger the target object to send information to the user owning the first device based on the MAC address and/or contact information of the user indicated by the first push information when determining that the target object needs to interact with the user owning the first device based on the first push information. In one or more examples, push information may be information transmitted by a first device to a second device that causes the second device to perform a predetermined action or operation.

Example implementations of the aforementioned method embodiment are illustrated below in connection with several specific application scenarios.

### Example 1: A Robot Guides a Customer

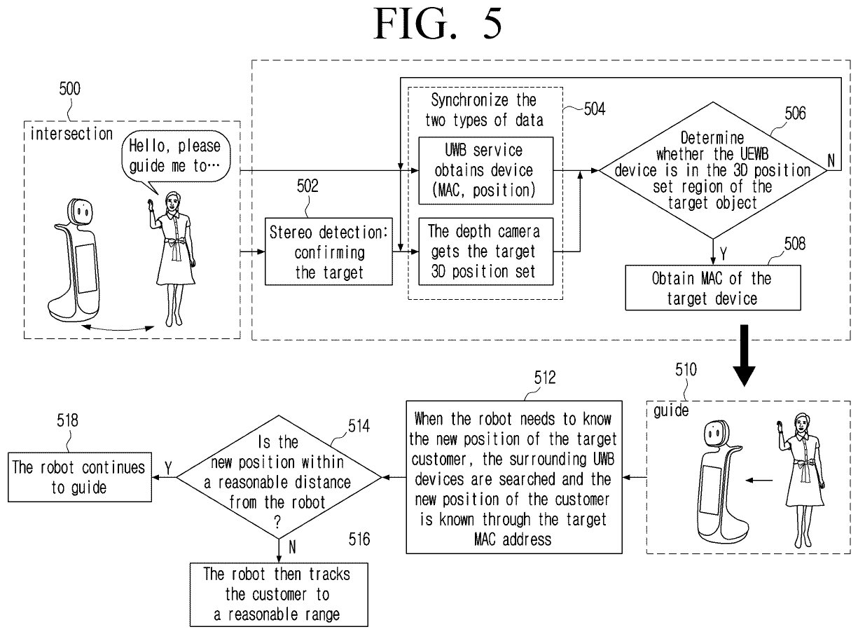

FIG. 5 shows a flowchart of implementing a robot guiding a customer in the aforementioned method embodiment. As shown in FIG. 5, when a robot detects an instruction of “Hello, please guide me to . . . ” issued by a customer (500), the robot will determine the customer as a target object (i.e. target person) through a stereo detection method (502). Synchronization of the two types of data may be performed (504) where a UWB service obtains device information (e.g., MAC, position) and a depth camera obtained target 3D position set data. If it is determined whether the UWB device is in a 3D positon set region of the target object (506), a MAC address of a target device carried by the customer is obtained using the aforementioned method embodiment (508). After obtaining the MAC address, the robot may guide the customer (510). Subsequently, a peripheral UWB device is searched when it is necessary to acquire a new position of the customer during the guidance process (512). The new position of the customer is obtained based on the MAC address of the target device. When the robot finds that the distance to the new position of the customer is no longer within a reasonable range, the robot moves within the reasonable range from the customer (516). If the robot determines that the distance to the new position of the customer is within a reasonable range, the robot continues to guide the customer (518).

As shown in FIG. 5, in the aforementioned process of customer guidance, the specific process of obtaining a MAC address (e.g., target MAC address) of a target device carried by the customer may be performed as follows:

Taking coordinates inside a depth camera as reference coordinates, the robot maps the device position obtained by a UWB Service into the camera coordinates.

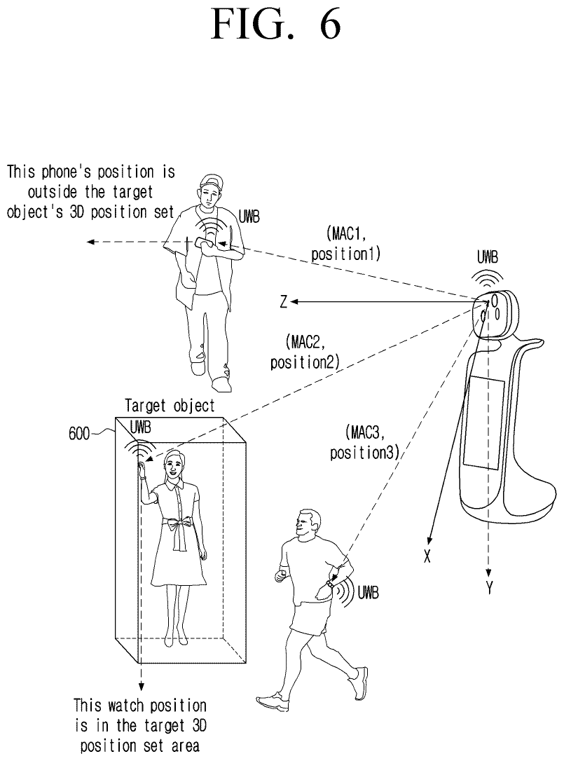

As shown in FIG. 6, the UWB service obtains a list of MAC and positions of UWB devices nearby as follows:
(MAC1, position1)
(MAC2, position2)
(MAC3, position3)

A space region 600 corresponding to a position set of a target person obtained by the depth camera is shown in FIG. 6. Position2 is in a three-dimensional position set region of the target person, and therefore the MAC of the target device is MAC2.

When the robot is required to find a new position of the target person in the aforementioned process of customer guidance, the process of obtaining the new position of the target person through the MAC (MAC2) of the target device is as follows:

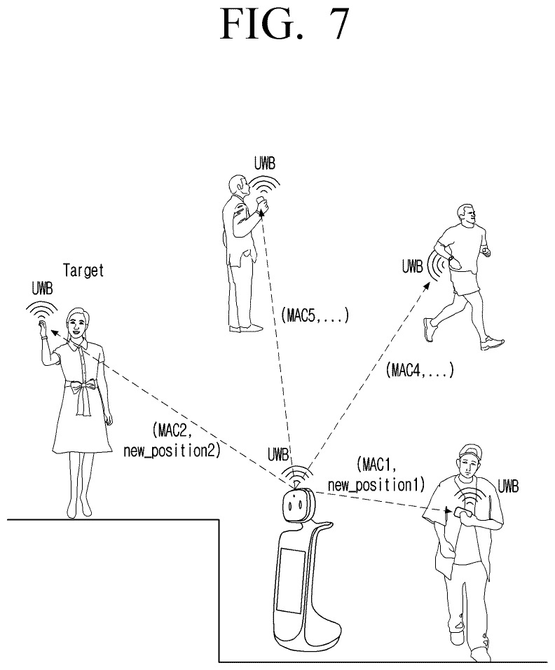

a. The UWB service of the robot starts searching for nearby UWB devices and obtains the MAC addresses and positions of peripheral devices. As shown in FIG. 7, the search results are as follows:
(MAC4, position4)
(MAC5, position5)
(MAC2, new_position2)
(MAC1, new_position1)

b. The MAC: MAC2 of the target device is found from a data list, and a new position: new_position2 is also obtained.

### Example 2: A Robot is Used to Enhance the Shopping Experience of a User

1. In Seoul, South Korea, a customer wants to take photos after shopping at the landmark shopping mall: Shilla duty-free store.

2. The customer makes a gesture or voice towards a robot to instruct the robot to take photos.

3. When the robot takes photos of the customer, a MAC address of a UWB device of the customer is obtained using the method according to the embodiments of the present disclosure.

4. After taking photos, the robot marks time and positions on the photos, and smartly sends the photos to the UWB device of the customer based on the MAC address of the UWB device of the customer.

### Example 3: Tag Information and Smart Interaction of a Target Person are Obtained in a Social Scenario

In this scenario, a user may automatically generate or edit tag information and store the tag information in a preset database, so as to be submitted to others who are allowed to obtain the tag information in a social scenario. For example, a terminal device of the user may generate tag data for the user according to behavior data of the user (for example, generate a tag of “sports enthusiast” based on a behavior of the user playing sports using a sports APP), store the generated information such as tag data, account name, password, device MAC, and display address in the preset database according to a user instruction, and set information such as the display address of the tag data in the database.

In an example social scenario, based on the aforementioned information in the database, in combination with the method for obtaining MAC addresses of devices in the present disclosure, the online and offline social experience can be improved. An example process of Example 3 in this scenario is as follows:

1. Boy A falls in love with a beautiful Girl B at first sight in a library.

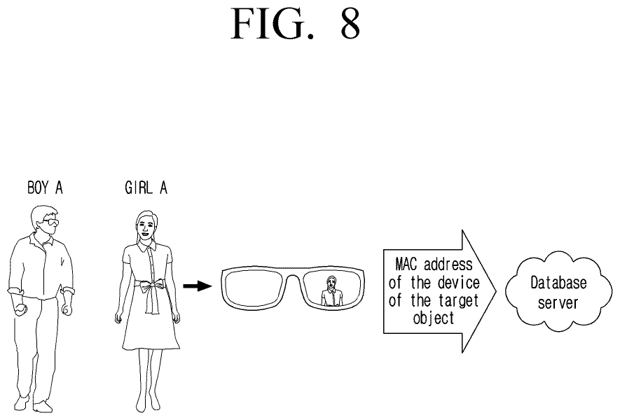

2. Boy A determines a target person as the aforementioned Girl B using AR glasses, obtains the device MAC and position of Girl B, and sends (MAC, position) to a designated database server (as shown in FIG. 8).

3. The database server returns a personality tag authorized by Girl B to be displayed at the library to Boy A.

4. The personality tag of Girl B obtained by Boy A shows that Girl B is a sports fan, and Boy A is also a sports fan. Therefore, Boy A is interested in Girl B and sends a message to Girl B through a UWB. This message contains related information about Boy A, including a relative position to Girl B, a chat account and/or a MAC address, etc.

5. Girl B is interested in the received information and returns a message to Boy A with the device MAC address or chat account, etc. of this boy.

6. After receiving the message, Boy A greets Girl B confidently without uneasiness.

In one or more examples, by means of the aforementioned method, a user may also use AR glasses to gaze at the back of a target person to obtain a personality tag, and therefore the convenience of finding new friends can be effectively increased.

### Example 4: Photos Captured by a Smart Phone are Shared Smartly. The Application of this Scenario is Exemplarily Illustrated Below by Two Examples 4.1 and 4.2

a. The specific process of Example 4.1 is as follows:

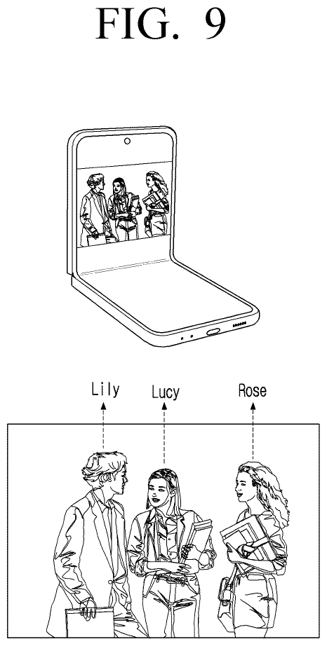

1. Lily takes a photo with her own folding phone. Lucy in the photo is her friend and Lucy has a picture in her phone. Rose is a friend of Lucy, and there is no photo or contact information in Lily's phone (as shown in FIG. 9).

2. Lily's phone determines Lucy as a target object through face recognition based on information in an album or address book thereof. Meanwhile, by using a depth camera, Rose in the photo is also determined as a target object (three-dimensional position sets of Rose and the target person Lucy are intersecting).

3. MAC addresses of respective UWB devices of Lucy and Rose are obtained through the UWB and the depth camera.

4. Lily's phone automatically sends the captured photos to Lucy and Rose based on the MAC addresses obtained in 3 above.

b. The specific process of Example 4.2 is as follows:

1. Mom takes photos of Dad A and Daughter B.

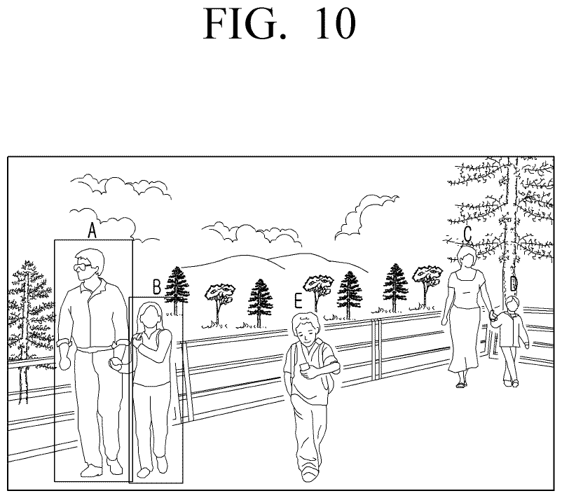

2. Mom's phone determines Dad A and Daughter B as target people through face recognition and comparison with photos in an album, or comparison with photos in the contacts. Furthermore, front-back and left-right distances are obtained through a depth camera (as shown in FIG. 10). Assuming that Dad C and Daughter D who are playing at a distance are also photographed at the same time, Dad C and Daughter D will not be determined as target people. Assuming that Friend E of Daughter A, who is close to Daughter A, is photographed at the same time, Friend E does not exist in the album and communication logs of Mom's phone, but Friend E will still be determined as a target person because the friend is close to Daughter A.

3. Mom's phone obtains device MAC addresses (MAC1 and MAC2) of Dad A and Daughter B through UWB positioning and the depth camera. MAC1 is a MAC address of a mobile phone in a pocket of Dad A, and MAC2 is a MAC address of a mobile phone in a pocket of Daughter B.

4. Mom's phone sends the captured photos to the mobile phones with the MAC addresses: MAC1 and MAC2, respectively.

As can be seen from the aforementioned examples 4.1 and 4.2, by applying the embodiments of the present disclosure to a photographing scenario, photos can be shared smartly. Since it is not necessary for a user to manually perform photo sharing, the convenience and efficiency of photo sharing can be improved.

### Example 5: Non-Dead Angle Smart Monitoring

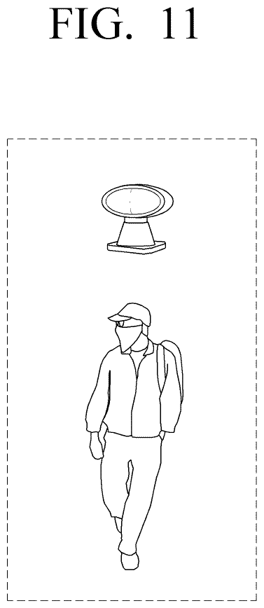

1. A monitoring device detects a person with an abnormal behavior within a visual range and determines the person as a target person (as shown in FIG. 11).

2. A MAC address of a UWB device (such as a mobile phone or a smart watch) of the target person is obtained.

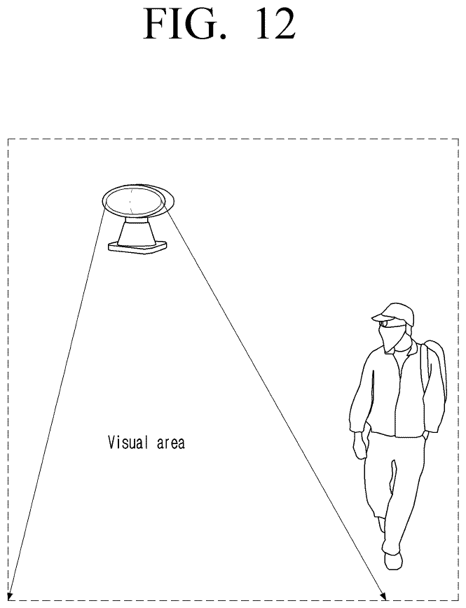

3. When the target person moves out of the visual range of the monitoring device (as shown in FIG. 12), devices nearby are scanned. Based on the MAC address of the UWB device of the target person, matching position information is obtained from currently scanned device information to obtain a current new position of the target person.

By means of the aforementioned example 5, not only non-dead angle monitoring can be realized within a UWB signal coverage range of the monitoring device, but also the re-positioning time of the target person can be shortened and the re-positioning efficiency of the target person can be improved by using the device MAC address of the target person.

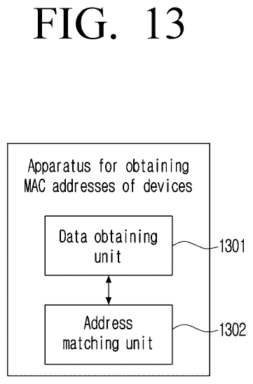

Corresponding to the aforementioned embodiments, one or more embodiments of the present application also proposes an apparatus for obtaining MAC addresses of devices. As shown in FIG. 13, the apparatus includes:

a data obtaining unit 1301, configured to obtain device information of a currently connectable UWB device using a UWB, and synchronously obtain first three-dimensional position set data of a target object, the device information including a MAC address and first position information; and

an address matching unit 1302, configured to determine a MAC address of the UWB device belonging to the target object based on the device information and the first three-dimensional position set data. In one or more examples, each of the data obtaining unit and address matching unit may be an integrated circuit or a processor.

It should be noted that the aforementioned method and apparatus embodiments are based on the same inventive concept. Since the principles of the method and apparatus for solving the problems are similar, the implementations of the apparatus and the method may be referred to each other, and the repetitions may be omitted.

Corresponding to the aforementioned method embodiment, one or more embodiments of the present application also proposes a device for obtaining MAC addresses of devices, including a processor and a memory. The memory stores an application executable by the processor for causing the processor to perform the method for obtaining MAC addresses of devices as described above. Specifically, a system or apparatus with a storage medium may be provided. A software program code that realizes the functions of any one implementation in the aforementioned embodiment is stored on the storage medium, and a computer (or a CPU or an MPU) of the system or apparatus is caused to read out and execute the program code stored in the storage medium. Furthermore, some or all of actual operations may be performed by means of an operating system or the like operating on the computer through instructions based on the program code. The program code read out from the storage medium may also be written into a memory provided in an expansion board inserted into the computer or into a memory provided in an expansion unit connected to the computer. Then, an instruction based on the program code causes a CPU or the like installed on the expansion board or the expansion unit to perform some or all of the actual operations, thereby realizing the functions of any one of the aforementioned method implementations for obtaining MAC addresses of devices.

The memory may be specifically implemented as various storage media such as an electrically erasable programmable read-only memory (EEPROM), a flash memory, a programmable program read-only memory (PROM), etc. The processor may be implemented to include one or more central processing units or one or more field programmable gate arrays. The field programmable gate arrays are integrated with one or more central processing unit cores. Specifically, the central processing unit or central processing unit core may be implemented as a CPU or an MCU.

One or more embodiments of the present application implements a computer program product, including computer programs/instructions. When executed by a processor, the computer programs/instructions implement the operations of the method for obtaining MAC addresses of devices as described above.

It should be noted that not all the operations and modules in the aforementioned flowcharts and structure diagrams are necessary, and some operations or modules may be omitted according to actual requirements. The order of execution of the various operations is not fixed and may be adjusted as required. The division of the various modules is merely to facilitate the description of the functional division adopted. In actual implementation, one module may be implemented by being divided into multiple modules. The functions of the multiple modules may also be realized by the same module. These modules may be located in the same device or in different devices.

Hardware modules in the various implementations may be implemented mechanically or electronically. For example, a hardware module may include a specially designed permanent circuit or logic device (e.g. a dedicated processor such as an FPGA or an ASIC) to perform a particular operation. The hardware module may also include a programmable logic device or circuit (e.g. including a general purpose processor or other programmable processors) temporarily configured by software to perform a particular operation. The implementation of the hardware modules mechanically, or using a dedicated permanent circuit, or using a temporarily configured circuit (e.g. configured by software) may be determined based on cost and time considerations.

As used herein, “schematic” means “serving as an instance, example, or illustration”. Any illustration and implementation described herein as “schematic” should not be construed as a more preferred or advantageous technical solution. For simplicity of the drawings, only those portions related to the present disclosure are schematically depicted in the figures and are not representative of an actual structure of a product. In addition, for simplicity and ease of understanding, only one of components having the same structure or function is schematically drawn or marked in some figures. As used herein, “one” does not mean to limit the number of portions related to the present disclosure to “only one”, and “one” does not mean to exclude the case that the number of portions related to the present disclosure is “more than one”. As used herein, “upper”, “lower”, “front”, “back”, “left”, “right”, “inner”, “outer”, and the like are used merely to indicate relative positional relationships between related portions, and do not limit absolute positions of these related portions.

The above description is merely preferred embodiments of the present disclosure and is not intended to limit the protection scope of the present disclosure. Any modifications, equivalent replacements, improvements, etc. that come within the spirit and principles of the present disclosure are intended to be within the protection scope of the present disclosure.

What is claimed is:

1. A method for obtaining a Media Access Control (MAC) address of a connectable ultra wide band (UWB) device, the method comprising:
obtaining, by a first device, device information of the connectable UWB device using a UWB signal;
obtaining, by the first device synchronously with the obtaining the device information, first three-dimensional position set data of a target object, the device information comprising the MAC address and first position information of the connectable UWB device; and
determining, by the first device, the MAC address of the connectable UWB device belonging to the target object based on the device information and the first three-dimensional position set data.

2. The method according to claim 1, wherein the obtaining the device information comprising the first position information of the connectable UWB device further comprises:
positioning, by the first device, the connectable UWB device using the UWB signal to obtain a position coordinate of the UWB device; and
mapping, by the first device, the position coordinate obtained by the positioning into a coordinate system corresponding to the first three-dimensional position set data to obtain the first position information of the connectable UWB device.

3. The method according to claim 1, wherein the obtaining the first three-dimensional position set data of the target object further comprises:
acquiring, by the first device while obtaining the device information, three-dimensional position set data of the target object using a depth camera;
selecting, by the first device from the acquired three-dimensional position set data, three-dimensional position set data acquired at a time closest to a first time corresponding to a time when the device information is obtained; and
obtaining, by the first device, the first three-dimensional position set data of the target object based on the selected three-dimensional position set data.

4. The method according to claim 3, wherein the obtaining the first three-dimensional position set data of the target object based on the selected three-dimensional position set data further comprises:
expanding, by the first device according to a preset expansion parameter, a space region corresponding to the selected three-dimensional position set data to obtain the first three-dimensional position set data of the target object.

5. The method according to claim 1, wherein the determining the MAC address of the connectable UWB device belonging to the target object further comprises:
searching, by the first device, for the connectable UWB device belonging to the target object by matching a device position of the UWB device with a target space region based on the first position information and the first three-dimensional position set data, wherein the target space region is a space region corresponding to the first three-dimensional position set data of the target object; and
obtaining, by the first device, the MAC address of the searched connectable UWB device based on the device information.

6. The method according to claim 5, further comprising:
obtaining, by the first device while obtaining the first three-dimensional position set data of the target object, first three-dimensional position set data of each second object, wherein each second object is an object other than the target object within a preset first expanded region where the target object is located,
wherein the searching for the connectable UWB device belonging to the target object further comprises:
searching, by the first device, for the connectable UWB device located in the target space region based on the first position information and the first three-dimensional position set data of the target object;
based on determining that the searched connectable UWB device does not exist in other space regions, determining, by the first device, the searched connectable UWB as the UWB device belonging to the target object; and
based on determining that the searched connectable UWB device exists in other space regions, determining, by the first device, that the search fails,
wherein the other space regions are space regions corresponding to the first three-dimensional position set data of the second object.

7. The method according to claim 6, wherein the obtaining the first three-dimensional position set data of each second object further comprises:
acquiring, by the first device while obtaining the device information, three-dimensional position set data of each second object using a depth camera;
selecting, by the first device from the acquired three-dimensional position set data of each second object, three-dimensional position set data acquired at a time closest to a first time corresponding to a time that the device information is obtained; and
obtaining, by the first device, the first three-dimensional position set data of each second object based on the selected three-dimensional position set data.

8. The method according to claim 7, wherein the obtaining the first three-dimensional position set data of each second object based on the selected three-dimensional position set data comprises:
expanding, by the first device according to a preset expansion parameter, a space region corresponding to the selected three-dimensional position set data to obtain the first three-dimensional position set data of the second object.

9. The method according to claim 1, further comprising:
after determining the MAC address of the connectable UWB device belonging to the target object,
based on determining the target object is required to be repositioned, obtaining, by the first device, the MAC address and position information of the connectable UWB device using the UWB signal, and
searching, by the first device, for position information that matches the determined MAC address from the obtained position information as current position information of the target object.

10. The method according to claim 1, further comprising:
after determining the MAC address of the connectable UWB device belonging to the target object, sending, by the first device, information required for the target object to the connectable UWB device belonging to the target object using the determined MAC address.

11. The method according to claim 1, further comprising:
after determining the MAC address of the connectable UWB device belonging to the target object, obtaining, by the first device, user tag information corresponding to the determined MAC address from a preset database;
generating, by the first device, first push information based on the user tag information, the first push information comprising generation of a MAC address of the first device or contact information of a user owning the first device; and
sending, by the first device, the first push information to the UWB device belonging to the target object based on the determined MAC address to trigger the target object to send information to the user owning the first device based on the MAC address or contact information of the user indicated by the first push information based on determining that the target object needs to interact with the user owning the first device based on the first push information.

12. The method according to claim 1,
wherein determining the target object comprises:
based on determining the first device receives a preset target object setting instruction, determining, by the first device, an object which issues the target object setting instruction as the target object; or,
wherein determining the target object comprises:
based on determining the first device detects that a duration for which a user owning the first device gazes at an object reaches a preset threshold, determining, by the first device, the gazed object as the target object; or,
wherein determining the target object comprises:
based on determining the first device detects that an object in a currently captured picture is known to a user owning the first device, determining, by the first device, the object as the target object;
obtaining, by the first device, first three-dimensional position set data of each second object using a depth camera, the second object being an object other than the target object within a preset first expanded region where the target object is located;
in a presence of the second object, searching for a second object having a distance, less than a preset threshold, to each of the determined target objects from the second object based on the first three-dimensional position set data of the second object and the first three-dimensional position set data of the target object, and based on determining the search is successful, determining, by the first device, the searched second object as the target object; or,
wherein determining the target object comprises:
based on determining the first device monitors an object having a preset abnormal behavior, determining, by the first device, the object as the target object.

13. A device for obtaining a Media Access Control (MAC) address of a connectable ultra wide band (UWB) device, the device comprising:
a memory that stores one or more instructions; and
a processor operatively coupled to the memory and configured to execute the one or more instructions stored in the memory,
wherein the one or more instructions, when executed by the processor, cause the device to:
obtain device information of the connectable UWB device using a UWB signal,
obtain, synchronously with obtaining the device information, first three-dimensional position set data of a target object, the device information comprising the MAC address and first position information of the connectable UWB device, and
determine the MAC address of the connectable UWB device belonging to the target object based on the device information and the first three-dimensional position set data.

14. The device according to claim 13,
wherein the one or more instructions, when executed by the processor, cause the device to:
position the connectable UWB device using the UWB signal to obtain a position coordinate of the UWB device; and
map the position coordinate obtained by the positioning into a coordinate system corresponding to the first three-dimensional position set data to obtain the first position information of the connectable UWB device.

15. The device according to claim 13,
wherein the one or more instructions, when executed by the processor, cause the device to:
acquire while obtaining the device information, three-dimensional position set data of the target object using a depth camera;
select from the acquired three-dimensional position set data, three-dimensional position set data acquired at a time closest to a first time corresponding to a time when the device information is obtained; and
obtain the first three-dimensional position set data of the target object based on the selected three-dimensional position set data.

16. The device according to claim 15,
wherein the one or more instructions, when executed by the processor, cause the device to:
expand according to a preset expansion parameter, a space region corresponding to the selected three-dimensional position set data to obtain the first three-dimensional position set data of the target object.

17. The device according to claim 13,
wherein the one or more instructions, when executed by the processor, cause the device to:
search for the connectable UWB device belonging to the target object by matching a device position of the UWB device with a target space region based on the first position information and the first three-dimensional position set data, wherein the target space region is a space region corresponding to the first three-dimensional position set data of the target object; and
obtain the MAC address of the searched connectable UWB device based on the device information.

18. The device according to claim 17,
wherein the one or more instructions, when executed by the processor, cause the device to:
obtain while obtaining the first three-dimensional position set data of the target object, first three-dimensional position set data of each second object, wherein each second object is an object other than the target object within a preset first expanded region where the target object is located,
search for the connectable UWB device located in the target space region based on the first position information and the first three-dimensional position set data of the target object; and
based on determining that the searched connectable UWB device does not exist in other space regions, determine the searched connectable UWB as the UWB device belonging to the target object; and
based on determining that the searched connectable UWB device exists in other space regions, determine that the search fails,
wherein the other space regions are space regions corresponding to the first three-dimensional position set data of the second object.

19. The device according to claim 18,
wherein the one or more instructions, when executed by the processor, cause the device to:
acquire while obtaining the device information, three-dimensional position set data of each second object using a depth camera;
select from the acquired three-dimensional position set data of each second object, three-dimensional position set data acquired at a time closest to a first time corresponding to a time that the device information is obtained; and
obtain the first three-dimensional position set data of each second object based on the selected three-dimensional position set data.

20. The device according to claim 19,
wherein the one or more instructions, when executed by the processor, cause the device to:
expand according to a preset expansion parameter, a space region corresponding to the selected three-dimensional position set data to obtain the first three-dimensional position set data of the second object.
